(19) United States
(12) Patent Application Publication
(10) Pub. No.: US 2020/0149224 A1
(43) Pub. Date: May 14, 2020

(54) METHOD FOR PRODUCTION OF SECURITY PAPER

(71) Applicants: TAGIT S.A., Neuchatel 4 (CH); SPM - SECURITY PAPER MILL, A.S., Praha (CZ)

(72) Inventors: Mario FUSE, Chigasaki, Kanagawa (JP); Ales NEHYBA, Neratovice (CZ); Vladimir MANOV, Hadera (IL)

(21) Appl. No.: 16/628,343

(22) PCT Filed: Jul. 3, 2018
(86) PCT No.: PCT/IL2018/050718

§ 371 Date: Jan. 3, 2020

Related U.S. Application Data
(60) Provisional application No. 62/528,730, filed on Jul. 5, 2017.

(51) Int. Cl. D21H 21/48; D21H 27/00; D21H 17/67; D21H 19/10; B42D 25/369

(52) U.S. Cl. CPC D21H 21/48; D21H 27/00; B42D 25/373; D21H 19/10; B42D 25/369; D21H 17/67

(57) ABSTRACT

A method of manufacturing a security paper is presented. The method comprises: preparing a composition A containing a mixture of softwood and hardwood pulp, and preparing a mixture β of a refined pulp and magnetic wires having predetermined magnetic properties; preparing a composition C by blending the mixture B and the composition A; diluting the composition C, and forming a pulp single layer D including the magnetic wires at a predetermined density; removing moisture from the pulp single layer D; forming at least one protective coating layer on at least one side of the paper; and calendering the paper, thereby obtaining a security paper structure with the magnetic wires fully embedded in the pulp single layer.

### TECHNOLOGICAL FIELD AND BACKGROUND

The present invention relates to a production method for production of a security paper of the type including magnetic wires/microwires, so as to enable detection of the presence of the magnetic wires in an EAS (Electronic Article Surveillance) system.

Various kinds of paper containing soft-magnetic microwires (tag) have been studied for the prevention of forgery, security for highly confidential information, and other purposes.

For example, U.S. Pat. No. 7,301,324 describes a recording medium and a detecting system for detection of such recording medium. The detection system includes a magnetic field-generating unit that generates an alternating magnetic field in a predetermined particular region, a detecting unit provided close to the particular region for detecting a change in magnetic flux, and a recording medium, that is detectable by the detecting unit when placed in the particular region. The recording medium may be a two-layered or three-layered structure containing magnetic wires. In the two-layer structure, the magnetic wires are placed on one face of a substrate previously prepared and laminating another substrate hereon. In the three-layered structure a single-layered substrate (or wet paper) containing dispersed wires is sandwiched between two substrates (or wet paper) containing no wires.

### GENERAL DESCRIPTION

The present invention provides a novel method of manufacture of a security paper (at times referred to as “recording medium”), which enables mass production of the security paper with high yield and high reproducibility.

The security paper is preferably configured as described in WO16170527, assigned to the assignee of the present application. Such security paper/recording medium comprises: a pulp structure formed by pulp fibers and carrying microwires, having a metal core of a predetermined material composition and an insulating layer coating on the metal core; and at least one coating layer on at least one side of the pulp structure. The pulp structure is a single-layer structure with the microwires fully embedded in the single layer.

For the effective detection of an object carrying magnetic wires (i.e. fast detection and sufficiently strong detection signals obtainable by commercially available EM gate systems), the number and the distribution of the magnetic wires are important factors to be controlled. Further, for the case of paper, on which information is to be printed, in order to enable better printing, the surface of the paper with the wires should be sufficiently flat. All these factors are important for the paper production process, and even more critical in the mass production of such paper.

The present invention provides a method of manufacturing a security paper carrying magnetic wires fully embedded in the paper. The method comprises: preparing a composition A containing a mixture of softwood and hardwood pulp, and preparing a mixture B of a refined pulp and magnetic wires having predetermined magnetic properties; preparing a composition C by blending the mixture B and the composition A; diluting the composition C, and forming a pulp single layer D including the magnetic wires at a predetermined density; removing moisture from the pulp single layer D; forming at least one protective coating layer on at least one side of the paper, and performing calendering of the paper with the at least one coating layer, thereby obtaining the security paper structure with the magnetic wires fully embedded in the pulp single layer.

Preferably, the calendaring comprises controlling pressure and temperature conditions applied to the paper such as to substantially not affect magnetic properties of the magnetic wires and thereby maintain the predetermined magnetic properties of the wires. Preferably, the temperature is at least 70° C.; and the pressure substantially does not exceed 4 MPa.

Preferably, the magnetic wires are arranged with the density of the magnetic wires higher than one magnetic wire per square centimeter.

The magnetic properties of the magnetic wire comprises: zero or negative magnetostriction and large Barkhausen effect.

The composition A, containing a mixture of softwood and hardwood pulp, may further include one or more of the following: coloring agent(s), whitening agent(s), reinforcing agent(s), and a filler. Alternatively or additionally, one or more of such agents and filters may be added to composition C.

The mixture B comprises a suspension of the refined pulp, preferably such that a ratio of the magnetic wire to the pulp suspension is 1:15 to 1:20 by weight. The composition B may be created by taking a part of composition A and mixing this part with magnetic wires in a ratio 1:15 to 1:20 by weight.

The preparation of the composition C may comprise adding the mixture B to the slowly agitated composition A at a ratio of 1:1000. As indicated above, the agent(s)/filter(s) may be added when preparing composition C.

Preferably, the formation of the pulp monolayer D comprises diluting the composition C to a predetermined concentration, pumped to a headbox of a paper machine, discharging the suspension from the head box slit, such that a dry substance contained in the composition C forms a paper web or sheet on a plastic wire. The speed of movement of the plastic wire and a flow rate of the composition C from the head box are controlled, to thereby control the density of the magnetic wires and uniformity of the magnetic wires distribution.

Preferably, the coating process, forming the protective coating layer on at least one side of the paper, is performed inline, the layer paper web being dried to a moisture content of less than 7%, followed by coating, the coat weight is 7 g per square meter.

The so-obtained paper structure (e.g. after being cut into sheets of paper), is inspected. This includes measurements of the magnetic properties and density of the embedded microwires, to determine whether the measured characteristics match the predetermine magnetic properties of the wires in the mixture B, to be sure the magnetic properties are maintained.

The invention also provides a security paper, prepared by the above-described method, wherein the security paper comprises an arrangement of magnetic wires with selected magnetic properties fully embedded in the paper with a predetermined density of the magnetic wires, such that the selected magnetic properties of the magnetic wires are substantially maintained.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A and 1B exemplify a recording medium that can be manufactured by the method of the invention, where FIG. 1A schematically illustrates a cross-sectional view of the recording medium, and FIG. 1B schematically illustrates the distribution of microwires in the recording medium; and

FIG. 2 illustrates a flow diagram of the method of the present invention for manufacturing the recording medium.

### DESCRIPTION OF THE INVENTION

The recording medium/security paper produced by the method of the invention includes a single pulp layer in which a large number of magnetic wires are fully embedded, being distributed at desirably high density and uniformly within the layer, and one side or both sides of said layer are coated with a coating layer. As indicated above, the recording medium may be configured as described in WO16170527, assigned to the assignee of the present application.

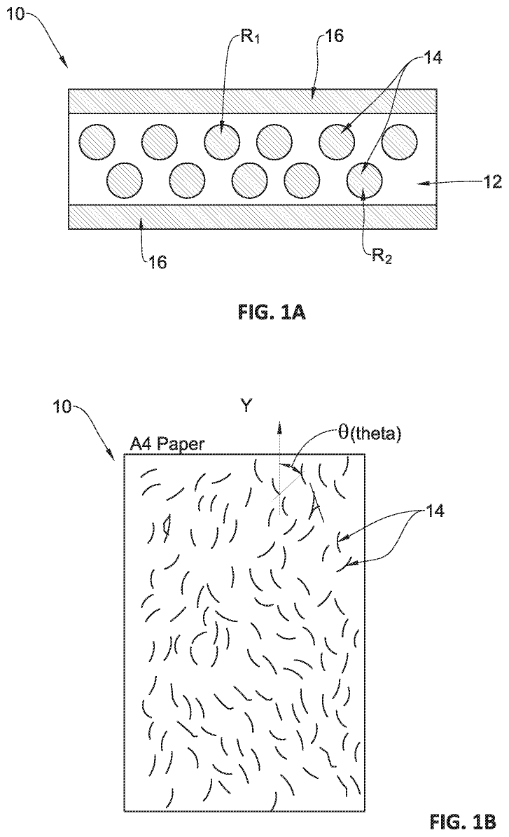

In this connection, reference is made to FIGS. 1A and 1B exemplifying the main features of such a recording medium 10. FIG. 1A is a cross-sectional view of the recording medium 10 showing that the recording medium includes a single pulp layer (constituting an active layer or a securing layer) 12 carrying an arrangement of magnetic microwires 14, embedded inside the layer 12, and at least one protective layer 16 coating the active layer 12 at least at one side thereof (two such protective coatings 16 being shown in the example of FIG. 1A provided at both sides of the pulp layer 12). As shown also in FIG. 1B, the microwires 14 are distributed within the entire active layer 12 (over entire recording medium 10). The microwires 14 are located inside the pulp layer 12 and may even be overlapping, i.e. arranged in more than one rows one above the other—two such rows being R₁ and R₂ being exemplified in the figure.

The thickness of the entire recording medium 10 (single-layer active structure 12 and double-sided coating 16) is about 80-120 μm. The magnetic wire is composed of a metal core and an insulator (like glass) covering the metal core. The metal core is made of a soft magnetic alloy having a large Barkhausen effect and has a cross-sectional dimension (diameter) in a range of 5-15 μm and a length in a range of 4-10 mm.

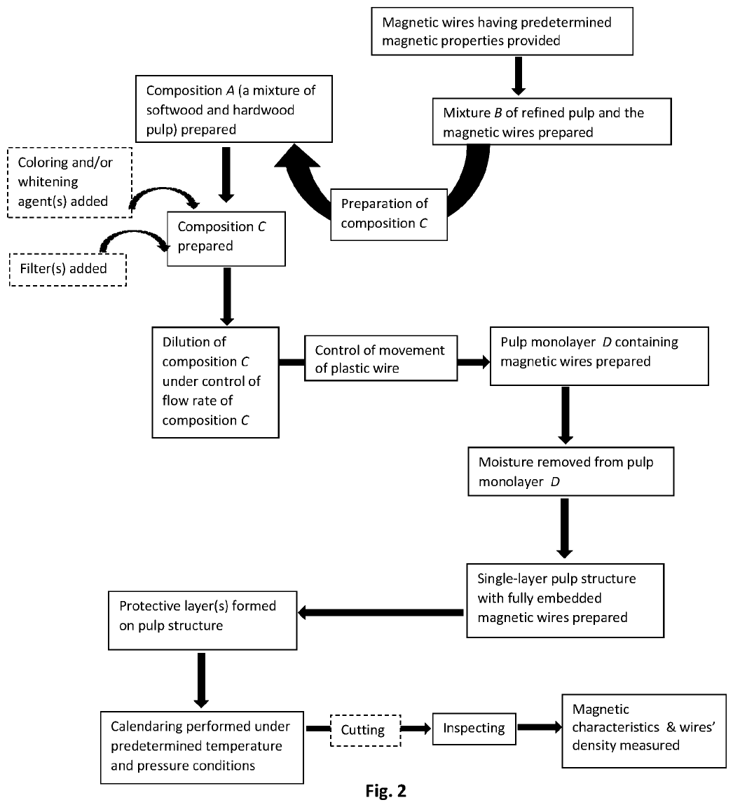

For the proper detection of the microwires embedded in the recording medium, a number of microwires and their distribution in the recording medium are important factors. FIG. 1B shows that in the recording medium 10 (e.g. paper of A4 format), the microwires are substantially uniformly distributed within the paper, being arranged with relatively high density and random orientation (defined by the tilt angle (theta) with respect to y-axis along the long side of A4 sheet). Referring to FIG. 2, there is illustrated a flow diagram of the main steps/stages in the production process of the security paper/recording medium, comprises an arrangement of magnetic wires with selected magnetic properties fully embedded in the paper with a predetermined density of the magnetic wires, such that the selected magnetic properties of the magnetic wires are substantially maintained.

Step 1: Preparation of “Composition A”, which contains a mixture of softwood and hardwood pulp;

Step 2: Preparation of “mixture B” of magnetic wires and refined pulp;

Step 3: Preparation of “Composition C” by blending of mixture B and composition A. As shown in the present example, preparation of composition C may be performed by adding the mixture B to the slowly agitated composition A.;

Step 4: Formation of a “pulp monolayer D” containing magnetic wire, by dilution of composition C;

Step 5: Moisture removal from pulp monolayer D, resulting in a single-layer pulp structure with fully embedded magnetic wires;

Step 6: Formation of coating layer; and

Step 7: Calendaring/finishing stage.

Then, the paper roll may be cut into sheet, and may undergo final inspection.

In particular, since steps/stages starting from step 4 are performed continuously inline, the production yield is also greatly improved.

In the following, each of the above steps is described in detail.

Preparation of Composition A (Step 1)

Composition A is prepared, which contains a mixture of softwood and hardwood pulp. More specifically, composition A is a mixture of softwood and hardwood pulp, and may also further include one or more of colorant and whitening agent, strength enhancing agents, filler. Composition A is typically a liquid-phase composition.

Examples of the strength enhancing agent include: cationic starch, carboxymethyl cellulose, mannogalactan. The filler is preferably added in an amount of at least 15-25% by weight, to improve the opacity and dimensional stability of the final paper. The filler may be a synthetic organic pigment based on calcium carbonate, titanium dioxide, kaolin or urea.

Preparation of Mixture B of Magnetic Wires and Refined Pulp (Step 2)

This stage involves mixing of magnetic wires with a suspension of refined pulp.

The magnetic wires may be previously prepared (in a so-called “off-line” step), using any known suitable technique for manufacture of glass-coated microwires. As described above, soft-magnetic microwire for use in a recording medium is capable of emitting large Barkhausen signals, which are caused by magnetization reversal, detectable with an EAS detector (typically, incorporated in a gate assembly). The microwire structure includes a soft-magnetic metal core coated with an insulating material, like a glass.

Glass coated microwires with amorphous metal cores have been developed and are described for example in U.S. Pat. Nos. 6,441,737 and 8,978,415. An example of a suitable material for the metal core is a cobalt-base alloy. For example, Co—Fe—Si—B alloy (e.g., containing 77.5% Co, 4.5% Fe, 12% Si, and 6% B by atomic percentage), Co—Fe—Si—B—Cr alloy (e.g., containing 68.7% Co, 3.8% Fe, 12.3% Si, 11.4% B, and 3.8% Cr by atomic percentage), or Co—Fe—Si—B—Cr—Mo alloy (e.g., containing 68.6% Co, 4.2% Fe, 12.6% Si, 11% B, 3.52% Cr and 0.08% Mo by atomic percentage) may be used.

As described below, it is desired that the soft-magnetic metal core has nearly zero or negative magnetostriction. For the purposes of paper-like recording medium production, if the metal core in a soft-magnetic microwire has positive magnetostriction, the large Barkhausen signal will be reduced or at worst diminished by the mechanical stress induced by the paper production process. The stress is typically applied during and after the paper production. For example, the pulp fiber elongates due to moisture and shrinks due to drying. The microwires are under such a stress in the pulp layer. On the other hand, when the soft-magnetic metal core has nearly zero or negative magnetostriction, the large Barkhausen signal will be more stable under stress applied on the microwires. Therefore, application of such stresses during the paper manufacture should be appropriately controlled. By controlling the alloy component, nearly zero or negative magnetostriction can be achieved. For example, while Co—Fe—Si—B—Cr alloy containing 67% Co, 5% Fe, 11% Si, 14% B, and 3% Cr by atomic percentage shows positive magnetostriction, Co—Fe—Si—B—Cr alloy containing 67.7% Co, 4.3% Fe, 11% Si, 14% B, and 3% Cr by atomic percentage shows nearly zero magnetostriction.

The diameter of the metal core in microwires, which is especially useful for security paper, can be in a range of 5-15 μm. The thickness of insulating material (e.g. glass) is in a range of 0.5-3 μm. This is because thicker (more than 3 μm thick) glass coating is practically fragile to mechanical stress applied during paper production and also paper handling in the printing and/or copying machine like an electro-photographic printer. When glass is broken in the paper production machine and/or the printing machine, glass particles contaminate inside the parts of the machine, which may increase machine maintenance cost due to the shortened cleaning cycle. The use of using thinner glass coating makes the microwire more flexible, and thus prevents the glass breaking effects. The glass-coated microwire may be fabricated using the continuous Taylor-Ulitovsky method, which is disclosed in the above-indicated U.S. Pat. No. 8,978,415, and then cut into pieces with the lengths of about 9-10 mm or less, preferably 4 mm to 7.5 mm.

Refined pulp is a soft or hardwood pulp that has undergone a mechanical treatment that is usually done in the papermaking process that increases the mechanical strength.

The concentration of the suspension of mixture B is preferably adjusted to be between 1.0 to 2.0%. The ratio of wires to pulp suspension is preferably 1:15 to 1:20 by weight. For example, the composition B with the proper content of magnetic wires may be prepared by mixing the magnetic wires with a part of the composition A.

In order to fully submerge and disperse the wires well during the preparation of mixture B, the wire is slowly stirred into the suspension.

Preparation of Composition C (Step 3)

The mixture B prepared as described above is blended with the composition A, after all the components have been mixed, but the shear forces are limited because it may affect the magnetic wires. By admixing the mixture B of magnetic wires and refined pulp with the composition A which produces a paper mass composed of a mixture of softwood and hardwood pulp, composition C is prepared.

When mixed, one or more of coloring agent(s) and whitening agent(s), as well as reinforcing agent(s) and filler(s), may be added. Various strength-enhancing agents can be used, such as cationic starch, carboxymethylcellulose, mannogalactan.

Also, a filler is added in an amount of at least 15-25% by weight to improve the opacity and dimensional stability of the final paper. The filler used may be a synthetic organic pigment based on calcium carbonate, titanium dioxide, kaolin or urea.

The consistency of such a composition is 3.0 to 4.0%.

The mixture B of magnetic wires and refined pulp is added into slowly agitated composition A. The ratio is 1:1000. Water is not added.

The amount of magnetic wires in the mixture B is estimated at 0.8 to 1.5·10⁷ per liter of mixture.

Dilution of Composition C and Forming Pulp Monolayer D Containing Magnetic Wire by Fourdrinier Machine (Step 4)

Composition C containing the magnetic wires prepared in the previous step is diluted to a consistency of less than 10 g/l and pumped to the headbox of a Fourdrinier machine. After dilution, 1 liter of suspension contains 2000 to 4000 magnetic wires.

From the headbox slit, it is drained and the dry matter contained in the composition C is poured onto a moving plastic wire forming a paper web (or sheet) over the plastic wire.

Through the above process for the composition C, a single layer of fiber mat is formed on Fourdrinier type machine.

By adjusting the speed of the moving plastic wire and the flow rate of composition C from the head box, the number of magnetic wires per unit area of the paper (density of the magnetic wires) can be determined with good reproducibility.

The uniform distribution of the wires depends largely on the adjustment of the wire density in the composition over two steps (Steps 3 and 4). In other words, controlling of the wire density (the number of magnetic wires per unit area of the paper) to be desirably high and the uniformity of the wires' distribution is controlled during the preparation of composition C (blending of mixture B and composition A, while slowly agitating composition A) and during dilution of composition C to form the pulp monolayer D. Loss of the magnetic wires is less than 5%, typically less than 2%, indicating that the process is ecological.

Moisture Removal of Pulp Monolayer D (Step 5)

After removing the moisture from the paper web (or sheet) with suction, the paper web is pressurized as it passes between the rolls placed under pressure and squeeze the water, and finally a series of steam heated cylinders. Moisture in the paper web is removed to include less than 7%.

Formation of Coating Layer. (Step 6)

In order to protect the wires from releasing out of paper (i.e. to be fully embedded in the paper) and to thereby ensure printability on the paper, the formation of the protective coating layer(s) (16 in FIG. 1A) is/are performed inline continuously to the previous step 5.

The coating layer is composed of a binder, a hydrophobizing agent, a humectants, a crosslinking agent, and a smoothing agent.

Examples of the binder include polyvinyl alcohol, cationic starch, styrene-acrylate, styrene-butadiene, polyvinyl acetate latex, mannogalactan and the like.

As the hydrophobizing agent, alkylketene dimer or styrene-maleic anhydride is exemplified.

As the humectant, higher alcohols are exemplified.

Examples of the crosslinking agent are glyoxal and carbodiimide.

As the smoothing agent, calcium stearate is exemplified.

The coating formation is carried out on a paper machine after the paper web has been dried to a moisture content of less than 7%, but before calendering. A size press (or similar device) may be used to apply the coating. Both sides of paper are preferably coated. The coat weight may be 7 g per square meter.

Calender Processing (Step 7)

Calendering process is performed after coating. A back-to-back calendar with two sets of cylinders is used to allow separate calendering of each paper web surface. Each set of cylinders includes rolls covered with steel rolls and elastomers. The roughness of the elastomeric roll may be Ra=0.05 micron. Each set of steel rolls is internally heated with water. The water content change of the paper web during the calendering process is less than 1%.

The inventors have found that the pressure applied on the web during the calendering process has a reduced effect on the detectability of the wire. As the pressure increased, a higher percentage of wires stopped showing the large Barkhousen effect. Therefore, calendering of such web is carried out at a high temperature of at least 70° C., preferably at least 80° C., and a low pressure of 4 MPa or less, preferably 3 MPa or less, so as not to damage the wires.

The paper-roll prepared as described above is a continuous paper web containing magnetic wires produced in a paper machine.

The paper-roll can then undergo a cutting step, during which it is cut into the paper size of the final product.

Since the magnetic wire used is thin, the lifetime of the cutting blade also becomes long.

Because of blade deterioration, there is an advantage that the customer's concern that the magnetic wire protrudes from the paper cut face is eliminated or at least greatly reduced.

The so prepared paper then undergoes final inspection. During this stage, the density of the magnetic wires is checked electronically by testing the operation of paper sheets in gates. To this end, magnetic response of the wires in the paper to a magnetic field applied by the gate is detected, and this data in analyzed to measure magnetic wires characteristics (Barkhausen effect), and count physically present amount of the magnetic wires on unit of square area of paper. The measured magnetic characteristics are analyzed to determine whether they match the magnetic properties of the wires in the mixture B, and thus the predetermined/desired magnetic properties are maintained.

1. A method of manufacturing a security paper carrying magnetic wires fully embedded in the paper, the method comprising:
preparing a composition A containing a mixture of softwood and hardwood pulp, and preparing a mixture B of a refined pulp and magnetic wires having predetermined magnetic properties,
preparing a composition C by blending the mixture B and the composition A,
diluting the composition C, and forming a pulp single layer D including the magnetic wires at a predetermined density,
removing moisture from the pulp single layer D, forming at least one protective coating layer on at least one side of the paper, and
performing calendering of the paper with the at least one coating layer, thereby obtaining the security paper structure with the magnetic wires fully embedded in the pulp single layer.

2. The method according to claim 1, wherein said calendaring comprises controlling pressure and temperature conditions applied to the paper to substantially not affect magnetic properties of the magnetic wires and thereby maintain said predetermined magnetic properties of the wires.

3. The method according to claim 2, wherein said temperature is at least 70° C.

4. The method according to claim 2, wherein said pressure substantially does not exceed 4 MPa.

5. The method according to claim 1, wherein the magnetic wires are arranged with the density of the magnetic wires higher than one magnetic wire per square centimeter.

6. The method according to claim 1, wherein the magnetic properties of the magnetic wire comprises zero or negative magnetostriction and large Barkhausen effect.

7. The method according to claim 1, wherein the composition A further comprises one or more of the following: coloring agent, whitening agent, reinforcing agent, and filler.

8. The method according to claim 1, wherein the mixture B comprises a suspension of the refined pulp, such that a ratio of the magnetic wire to the pulp suspension is 1:15 to 1:20 by weight.

9. The method according to claim 1, wherein the preparation of the composition C comprises adding the mixture B to the slowly agitated composition A at a ratio of 1:1000.

10. The method according to claim 9, wherein the preparation of the composition C comprises adding one or more of the following: coloring agent, whitening agent, reinforcing agent, and filler.

11. The method according to claim 1, wherein the formation of the pulp monolayer D comprises dilating the composition C to a predetermined concentration, pumped to a head box of a paper machine, discharging the suspension from the head box slit, such that a dry substance contained in the composition C forms a paper web or sheet on a plastic wire.

12. The method according to claim 11, comprising controlling a speed of movement of the plastic wire and a flow rate of the composition C from the head box, to thereby control density of the magnetic wires and uniformity of the magnetic wires distribution.

13. The method according to claim 1, wherein the coating process is performed inline, the layer paper web being dried to a moisture content of less than 7%, followed by coating, the coat weight is 7 g per square meter.

14. The method according to claim 1, comprising inspecting the security paper structure with the magnetic wires fully embedded in the pulp single layer, said inspecting comprising measuring the magnetic properties and density of the embedded microwires, and determining whether the measured characteristics match said predetermine magnetic properties of the wires in the mixture B.

15. A security paper comprising an arrangement of magnetic wires with selected magnetic properties fully embedded in the paper with a predetermined density of the magnetic wires, the security paper being manufactured by the method of claim 1, such that said selected magnetic properties of the magnetic wires are substantially maintained.

16. A method of manufacturing a security paper carrying magnetic wires fully embedded in the paper, the method comprising:
preparing a composition A containing a mixture of softwood and hardwood pulp, and preparing a mixture B of a refined pulp and magnetic wires having predetermined magnetic properties,
preparing a composition C by blending the mixture B and the composition A, wherein the mixture B is added to the slowly agitated composition A at a ratio of 1:1000,
diluting the composition C, and forming a pulp single layer D including the magnetic wires at a predetermined density, and removing moisture from the pulp single layer D, wherein formation of the pulp single layer D comprises dilating the composition C to a predetermined concentration, pumped to a head box of a paper machine, and discharging the suspension from the head box slit, such that a dry substance contained in the composition C forms a paper web or sheet on a plastic wire,
forming at least one protective coating layer on at least one side of the paper, and
performing calendering of the paper with the at least one coating layer by controlling pressure and temperature conditions applied to the paper, to substantially not affect magnetic properties of the magnetic wires and thereby maintain said predetermined magnetic properties of the wires, thereby obtaining the security paper structure with the magnetic wires having said magnetic properties fully embedded in the pulp single layer.

17. The method according to claim 16, comprising controlling a speed of movement of the plastic wire and a flow rate of the composition C from the head box, to thereby control density of the magnetic wires and uniformity of the magnetic wires distribution.

18. The method according to claim 17, wherein the magnetic wires are arranged with the density of the magnetic wires higher than one magnetic wire per square centimeter.
